(19) United States
(12) Patent Application Publication
(10) Pub. No.: US 2026/0145434 A1
(43) Pub. Date: May 28, 2026

(54) INK REPLENISHING CONTAINER, METHOD OF REMANUFACTURING INK REPLENISHING CONTAINER, AND METHOD OF REUSING INK REPLENISHING CONTAINER

(71) Applicant: CANON KABUSHIKI KAISHA, Tokyo (JP)

(72) Inventor: SATOSHI IBE, Kanagawa (JP)

(21) Appl. No.: 19/388,617

(22) Filed: Nov. 13, 2025

(30) Foreign Application Priority Data
Nov. 27, 2024 (JP) 2024-206804

(51) Int. Cl. B41J 2/175

(52) U.S. Cl. CPC B41J 2/17513; B41J 2/17509; B41J 2/17553; B41J 2/17559; B41J 2002/17516

(57) ABSTRACT

An ink replenishing container for replenishing a recording device with ink. The ink replenishing container includes an ink storage bag that stores ink therein and that has at one end portion thereof a lead-out opening. The ink replenishing container has a container portion that accommodates the ink storage bag, in which the ink storage bag leads the ink in the ink storage bag out of the lead-out opening and decreases in volume, and in which at least a part of a regulating member is accommodated in the ink storage bag, the regulating member being provided for, in an orientation in which the ink in the ink storage bag is led out of the ink storage bag, coming into contact with the ink storage bag and regulating bending of another end portion opposite to the one end portion with respect to a vertical direction.

### BACKGROUND

### Field of the Technology

The present disclosure relates to an ink replenishing container, a method of remanufacturing the ink replenishing container, and a method of reusing the ink replenishing container.

### Description of the Related Art

In a type of inkjet printer that performs recording on a recording medium, such as paper, by discharging ink onto the recording medium from a head that discharges the ink, an ink tank of an apparatus body is replenished with ink from an ink replenishing container. In general, such an ink replenishing container is advantageous in that it has a large ink capacity and in that it is environmentally friendly compared to, for example, other ink cartridges that are ink tanks. Further, in recent years, in order to achieve a sustainable society, such as a decarbonized society/circular society, there has been a demand for dealing with 3 R. 3 R refers to “reuse” meaning repeatedly using used products or components thereof, “recycle” meaning effectively using, for example, waste as raw materials or energy sources, and “reduce” meaning reducing the amount of waste.

As a technology that satisfies such a demand, for example, Japanese Patent Laid-Open No. 2022-13034 describes a technology of reducing the volume of members to be discarded by easily reusing a part of a used ink replenishing container. Specifically, since, by accommodating an ink storage bag, made of a stretchy material, in a container portion of the ink replenishing container and by storing ink in the ink storage bag, the container portion does not contact the ink, the container portion can be easily reused.

However, in the ink replenishing container that is described in Japanese Patent Laid-Open No. 2022-13034, since a lead-out portion of the ink replenishing container is oriented downward and an ink tank of an apparatus body is replenished with ink, when the amount of ink in the ink storage bag decreases, the ink storage bag may change its shape and fall down. More specifically, in an orientation in which ink in the ink storage bag is led out of the ink storage bag, one end portion of the ink storage bag may bend with respect to a vertical direction. In addition, a part of the ink storage bag may close and ink accumulated at this portion may not be led out of the ink replenishing container. In such a case, a user may discard the ink replenishing container without realizing that there is residual ink in the ink replenishing container, more time and effort are required due to, for example, cleaning of the inside of the ink replenishing container when the ink replenishing container is being reused and recycled, and thus environmental load may increase. When the accumulated ink in the ink replenishing container is discharged to the outside from the ink replenishing container without being intended by the user, the discharge may greatly affect the outside because what is stored is ink.

### SUMMARY

In view of the above-described problems, the present disclosure is directed to the provision of an ink replenishing container that is easily reused and recycled by, when an apparatus body is replenished with ink from an ink replenishing container, suppressing closure of an ink storage bag and by decreasing the amount of residual ink in the ink storage bag. The present disclosure is further directed to the provision of a method of remanufacturing such an ink replenishing container and a method of reusing such an ink replenishing container.

According to an aspect of the present disclosure, there is provided an ink replenishing container for replenishing a recording device with ink, the recording device including an ink tank including a replenishing opening and a cap, the replenishing opening opening toward a direction having a vertical direction component and the cap sealing the replenishing opening. The ink replenishing container includes an ink storage bag that stores ink therein and that has, at one end portion thereof, a lead-out opening out of which the ink is led out, and a container portion that accommodates the ink storage bag. The ink storage bag leads the ink in the ink storage bag out of the lead-out opening and decreases in volume. At least a part of a regulating member is accommodated in the ink storage bag, the regulating member being provided for, in an orientation in which the ink in the ink storage bag is led out of the ink storage bag, coming into contact with the ink storage bag and regulating bending of another end portion opposite to the one end portion with respect to the vertical direction.

Features of the present disclosure will become apparent from the following description of embodiments with reference to the attached drawings. The following description of embodiments is described by way of example.

### BRIEF DESCRIPTION OF THE DRAWINGS

FIG. 1 is an external perspective view of an inkjet printer.

FIG. 2 is a perspective view illustrating an internal structure of the inkjet printer.

FIG. 3 is a schematic view illustrating an ink supply system of the inkjet printer.

FIG. 4 is a schematic view illustrating a state of replenishing one ink tank with ink from one ink replenishing container.

FIG. 5 is a front view of one ink replenishing container.

FIG. 6 is a cross-sectional schematic view of the ink replenishing container.

FIG. 7 is an enlarged view of the vicinity of a nozzle of the ink replenishing container.

FIGS. 8A and 8B are each a cross-sectional schematic view of one ink tank and one ink replenishing container when replenishing with ink.

FIG. 9 is a perspective view of a regulating member.

FIG. 10 is a cross-sectional view of an ink replenishing container according to a second embodiment.

FIG. 11 is a perspective view of a regulating member according to the second embodiment.

FIG. 12 is a flowchart illustrating reuse and remanufacturing of an ink replenishing container.

FIG. 13A is an external perspective view of an ink replenishing container, and

FIG. 13B is a cross-sectional view of the ink replenishing container.

FIGS. 14A to 14C are detailed cross-sectional views of hermetically sealing structures of the ink replenishing container, with FIG. 14A being a cross-sectional view of an upper portion of the ink replenishing container with a cap being mounted on a nozzle portion, FIG. 14B being a cross-sectional view of the upper portion of the ink replenishing container with the cap not being mounted on the nozzle portion, and FIG. 14C being a cross-sectional view of the upper portion of the ink replenishing container with detachment of the cap being started.

FIG. 15 is a perspective view of an ink tank.

### DESCRIPTION OF THE EMBODIMENTS

Embodiments of the present disclosure are described below with reference to the drawings. It should be noted that the embodiments below do not limit matters of the present disclosure and that not all combinations of the features that are described in the present embodiments are necessarily required for solving the problems of the present disclosure. Corresponding constituent elements are given the same reference numerals.

### First Embodiment

### Inkjet Printer

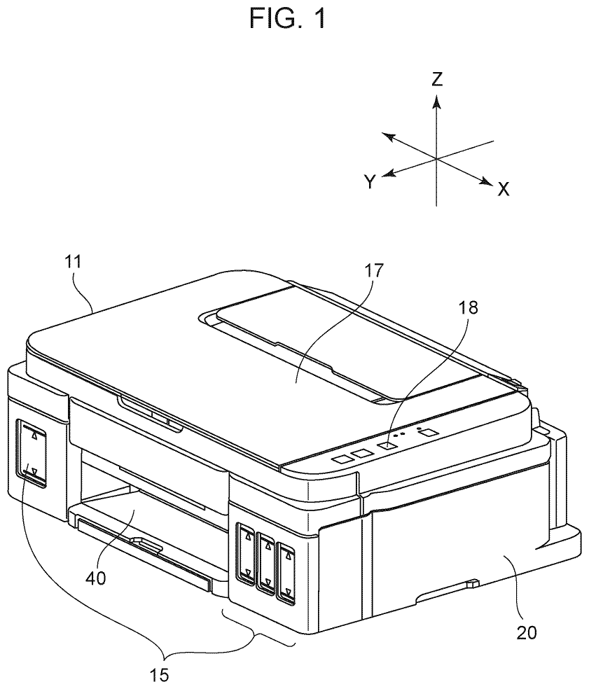

FIG. 1 is an external perspective view illustrating an outline of an inkjet printer 11 of the present embodiment. The inkjet printer 11 of the present embodiment is a recording device that records an image on a recording medium by discharging liquid ink onto the recording medium from a liquid discharging head (hereunder referred to as “head”), and is an example of a liquid discharging device that discharges a liquid.

While, in the present embodiment, an inkjet printer is described as an example, the liquid discharging device of the present disclosure is not limited to an inkjet printer as long as the liquid discharging device has a structure that can replenish a liquid tank of an apparatus body with a liquid from a liquid replenishing container. It should be noted that, in the description below, a width direction of the inkjet printer 11 is an X direction, a depth direction of the inkjet printer 11 is a Y direction, and a direction perpendicular to the X direction and the Y direction is a Z direction.

When the inkjet printer 11 is installed in a horizontal plane, the Z direction is parallel to a vertical direction.

As described below, a main scanning direction of the head is parallel to the X direction, and a conveying direction of a recording medium is parallel to the Y direction.

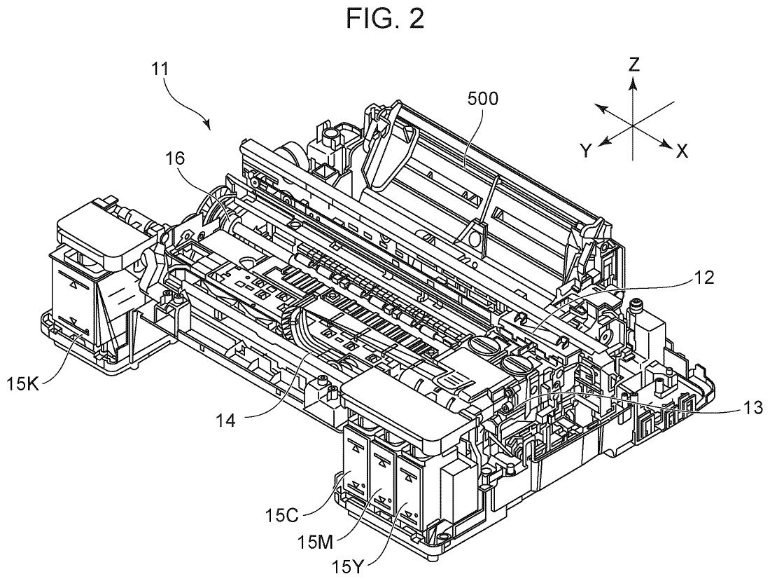

As shown in FIG. 1, the inkjet printer 11 includes a housing (exterior portion) 20, a head 13 (see FIG. 2) that performs a recording operation on a recording medium (not shown), and ink tanks 15 that serve as ink storage containers that store ink that is supplied to the head 13. In the present embodiment, the ink tanks 15 are disposed on a front side (+Y direction side) of the housing 20, and are fixed to the inkjet printer 11. An upper portion of the housing 20 is provided with a scanner unit 17 that reads an original and an operation inputting unit 18 that allows operations, such as an input of an instruction by a user, to be performed.

FIG. 2 is a perspective view illustrating an internal structure of the inkjet printer 11. The inkjet printer 11 includes a sheet feeding unit 500 that feeds recording media, a conveying roller 16 that conveys the recording media, and a discharging unit 40 (see FIG. 1) that discharges the recording media. The recording media are fed from the sheet feeding unit 500 into the inkjet printer 11 by a roller (not shown). The fed recording media are, while being conveyed by the conveying roller 16, subjected to a recording operation by the head 13. The recording media after the recording has been completed are discharged to the outside of the inkjet printer 11 from the discharging unit 40. As described above, a direction in which recording media are conveyed (Y direction) is referred to as the conveying direction.

A carriage 12 moves along the main scanning direction (the X direction) that intersects the conveying direction of the recording media by a driving source (not shown). In the present embodiment, the conveying direction and the main scanning direction are orthogonal to each other.

The head 13 is mounted on the carriage 12, and performs a recording operation to record an image corresponding to one band on a recording medium by discharging ink drops while moving in the main scanning direction.

When the image corresponding to one band is recorded on the recording medium, the recording medium is conveyed in the conveying direction by a predetermined amount by the conveying roller 16 (intermittent conveyance operation). By repeating the recording operation for one band and the intermittent conveyance operation, an image is recorded on the entire recording medium.

Further, the inkjet printer 11 includes a maintenance unit that maintains the head 13 in a movement region of the carriage 12 in the main scanning direction.

The inkjet printer 11 includes the ink tanks 15, which store ink used in recording, based on ink colors. As shown in FIG. 2, the inkjet printer includes a black ink tank 15K for black ink, a cyan ink tank 15C for cyan ink, a magenta ink tank 15M for magenta ink, and a yellow ink tank 15Y for yellow ink.

When a description can be made without distinguishing between the ink colors, that is, when a common structure is described without being based on the ink colors, the ink tanks may be referred to simply as the “ink tanks 15” in shortened form without the letters Y, M, C, and K that indicate the respective ink colors.

The black ink tank 15K is provided on the left side of the discharging unit 40 when the inkjet printer 11 is viewed from the front side (the +Y direction side) thereof. In contrast, the color-ink ink tanks (the cyan ink tank 15C, the magenta ink tank 15M, and the yellow ink tank 15Y) are provided on the right side of the discharging unit 40 when the inkjet printer 11 is viewed from the front side. The discharging unit 40 is provided between the black ink tank 15K and the color-ink ink tanks.

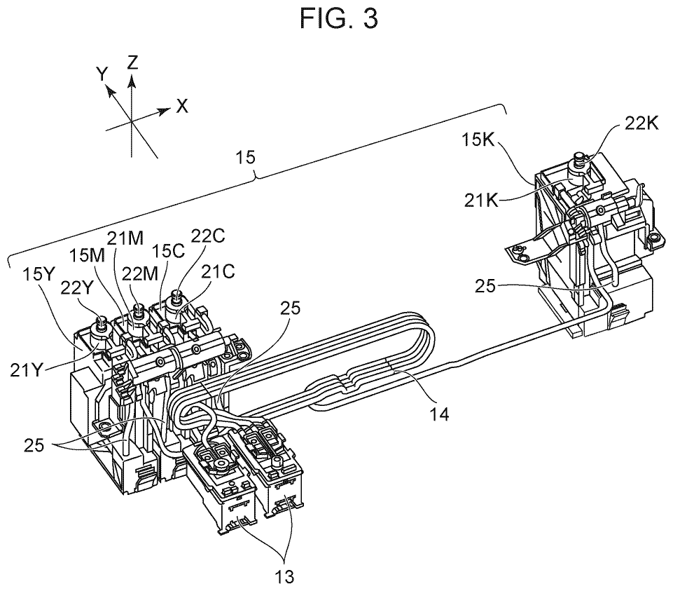

FIG. 3 is a perspective view illustrating an ink supply system of the inkjet printer 11, and illustrates the inkjet printer 11 when viewed from the rear (a-Y direction side) of the inkjet printer 11. The ink tanks 15 are provided based on the ink colors. A flexible tube that forms an ink supply path 14 (an ink flow path) for supplying ink to the head 13 is attached to each ink tank 15.

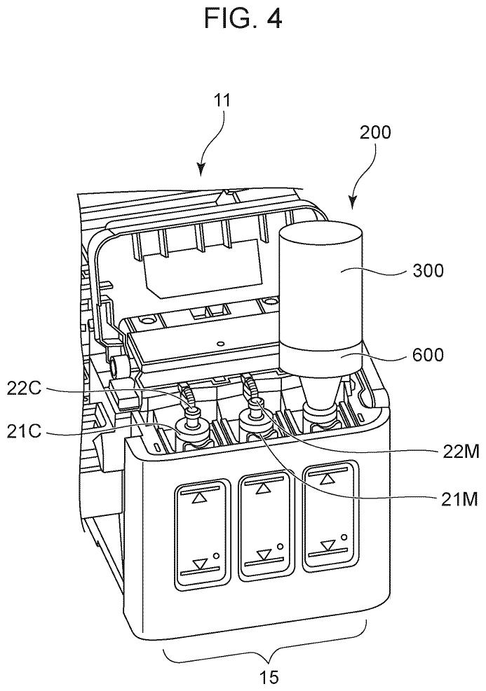

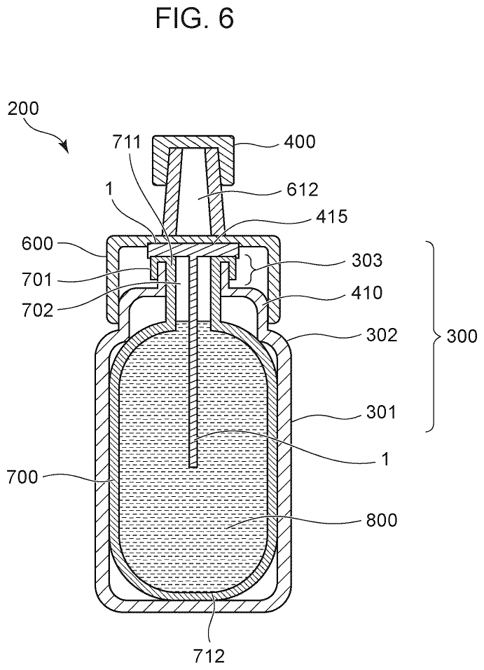

A flexible tube that forms an air communication passage for communicating the inside of each ink tank 15 with the atmosphere is attached to each ink tank 15. FIG. 4 is a perspective view illustrating a state of replenishing one ink tank 15 of the inkjet printer 11 with ink 800 (see FIG. 6) from an ink replenishing container 200 (ink bottle).

An upper portion of each ink tank 15 has a replenishing opening 122 through which a user injects ink into each ink tank 15. Each replenishing opening 122 opens toward a direction having a vertical direction component. Ink injected (supplied) from each replenishing opening 122 is stored in a tank portion 12 of each ink tank 15. Caps 123 (tank caps) for sealing the replenishing openings 122 are each attachably and detachably attached to a corresponding one of the replenishing openings 122. A user can inject ink into the ink tanks 15 from ink replenishing containers 200 by detaching the caps 123 and connecting nozzle portions 600 of the ink replenishing containers 200 to the respective replenishing openings 122.

### Ink Replenishing Container

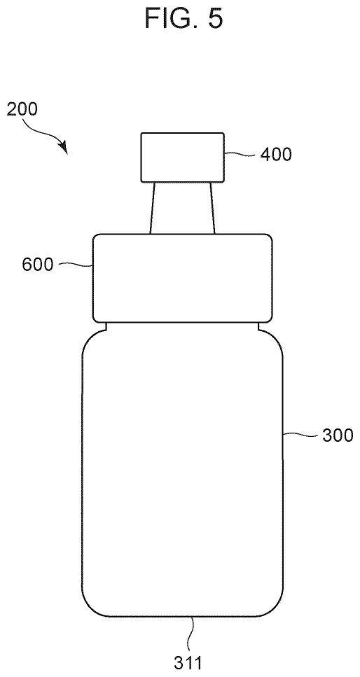

FIG. 5 is a front view of one ink replenishing container 200 in an ordinary position disposed state. “Ordinary position disposed state” refers to a state in which a bottom portion 311 of the ink replenishing container 200 is placed in a horizontal plane. The ink replenishing container 200 includes a container portion 300, the nozzle portion 600, and a cap 400.

With ink being capable of being led out of a lead-out opening 702 (may also be referred to as a “first lead-out opening”) of an ink storage bag 700 (described below), the ink storage bag is accommodated in the container portion 300 (FIG. 6). The lead-out opening 702 is provided at one end portion 711 (FIG. 6) of the ink storage bag 700. The nozzle portion 600 is attachably and detachably provided on the container portion 300. By connecting a tip portion of the nozzle portion 600 to the replenishing opening 122 of one ink tank 15, ink in the container portion 300 is injected into the ink tank 15 through the nozzle portion 600. This makes it possible to replenish the ink tank 15 with the ink from the ink replenishing container 200. The cap 400 is attachable to and detachable from the tip portion of the nozzle portion 600, and by mounting the cap 400 on the nozzle portion 600, an opening of the nozzle portion 600 is hermetically sealed, and by detaching the cap 400 from the nozzle portion 600, the opening of the nozzle portion 600 is uncovered.

FIG. 6 is a cross-sectional view illustrating an internal structure of the ink replenishing container 200. The container portion 300 in the ordinary position disposed state includes in order from a lower side a cylindrical portion 301, a shoulder portion 302, and a neck portion 303. The cylindrical portion 301 has a cylindrical shape having a bottom. A direction in which the cylindrical shape extends is referred to as an axial direction (also referred to as a “longitudinal direction”) of the container portion 300 and the ink replenishing container 200, and a direction perpendicular to the axial direction is referred to as a radial direction. In the ordinary position disposed state, the axial direction is parallel to a vertical direction.

The shape of the bottom portion 311 can be, for example, a circular shape, a rectangular shape, or a polygonal shape, and is not particularly limited. The shoulder portion 302 having an inside diameter and an outside diameter that are smaller than the inside diameter and the outside diameter of the cylindrical portion 301 is provided on a side opposite to a bottom portion of the cylindrical portion 301. The neck portion 303 having an inside diameter and an outside diameter that are smaller than the inside diameter and the outside diameter of the shoulder portion 302 is provided on a side opposite to the cylindrical portion 301 at the shoulder portion 302. An opening that allows ink in the container portion 300 to flow out to the outside is provided on a side opposite to the shoulder portion 302 at the neck portion 303.

The ink storage bag 700 that stores ink therein and that has the lead-out opening 702 that allows the stored ink to be led out is accommodated in the container portion 300. The ink storage bag 700 is an ink storage member having the shape of a bag and that can store the ink 800. The ink storage bag 700 has a size that allows it to be accommodated in the container portion 300. The container portion 300 can accommodate the ink storage bag 700 in a state in which ink can be poured out of the lead-out opening 702.

FIG. 6 illustrates a state in which the ink 800 is stored on an inner side of the ink storage bag 700. It is preferable that the ink storage bag 700 be made of a stretchy material. It is more preferable that the stretchy material include at least one material selected from the group consisting of butyl rubber, ethylene propylene rubber, silicone rubber, and thermoplastic elastomer. It should be noted that the ink storage bag 700 may be made of a material other than a stretchy material. When the ink storage bag 700 is not made of a stretchy material, it is preferable that a regulating member 1 that is described below extend up to the vicinity of the bottom portion 311 of the container portion 300.

An open end 701 of the ink storage bag 700 extends outward in a radial direction, turns back downward in an axial direction, and is attachably and detachably mounted on the neck portion 303 of the container portion 300 due to an elastic force directed inward in the radial direction and produced by elastic deformation of the ink storage bag 700 itself. It should be noted that the ink storage bag 700 may be placed between an outer peripheral surface of a seal member having an opening and an inner peripheral surface of the neck portion 303 by inserting the seal member onto the neck portion 303. This makes it possible to firmly fix the ink storage bag 700.

As ink in the ink storage bag 700 is led out of the lead-out opening 702, the volume of the ink storage bag 700 decreases. The ink storage bag 700 is brought into a separable state from the container portion 300. Since, when the ink storage bag 700 is separated from the container portion 300, a portion to which the ink 800 has adhered is separated from the container portion 300, the container portion 300 no longer has a portion to which the ink 800 is adhered. Therefore, it is possible to reuse the remaining container portion 300. When the container portion 300 is to be reused, a new ink storage bag 700 is accommodated in the container portion 300, and new ink 800 is stored at an inner side of the new ink storage bag 700. A method of remanufacturing the ink replenishing container 200 and a method of reusing the ink replenishing container 200 are described below.

The nozzle portion 600 is attachable to and detachable from the container portion 300. The nozzle portion 600 includes a communicating portion 602 that communicates with the lead-out opening 702 of the ink storage bag 700, and an opening portion 610 that opens the communicating portion to the outside. Further, the nozzle portion 600 includes a container attaching portion 603 and a cap-portion attaching portion 609. The cap 400 is attachably and detachably provided on the cap attaching portion 609. A tip portion 601 of the cap attaching portion 609 includes the opening portion 610 out of which ink can flow, and has a shape that can be connected to a replenishing opening 122 of one ink tank 15. An ink flow path 612 through which ink can flow is formed on an inner side of the cap attaching portion 609. The ink flow path 612 communicates with the lead-out opening 702 through the communicating portion 602 with the nozzle portion 600 being attached to the container portion 300. Ink in the container portion 300 flows to the tip portion 601 of the nozzle portion 600 through the lead-out opening 702 and the communicating portion 602. The ink flow path 612 communicates with the lead-out opening 702 through the communicating portion 602 with the nozzle portion 600 being attached to the container portion 300. Ink in the container portion 300 flows to the tip portion 601 of the nozzle portion 600 through the lead-out opening 702 and the communicating portion 602.

Further, the ink replenishing container 200 according to the present embodiment includes the regulating member 1 that regulates a decrease in the volume of the ink storage bag when ink in the ink storage bag is led out of the ink storage bag. The regulating member 1 is a member that is fixed in the vicinity of the communicating portion 602 of the nozzle portion 600 and that can prevent the ink storage bag from falling down. In other words, in an orientation in which the ink in the ink storage bag is led out of the ink storage bag, the regulating member 1 comes into contact with the ink storage bag and regulates bending of another end portion 712 opposite to the one end portion 711 with respect to a vertical direction. The shape of the regulating member 1 is not particularly limited, and, as described below, may be any shape that can suppress the other end portion 712 of the ink storage bag 700 from falling down and from being closed when the apparatus is being replenished with ink from the ink replenishing container.

The container attaching portion 603 is attachable to and detachable from the shoulder portion 302 of the container portion 300. By fixing the container attaching portion 603 to the shoulder portion 302, the nozzle portion 600 is attached to the container portion 300. By detaching the container attaching portion 603 from the shoulder portion 302, the nozzle portion 600 is detached from the container portion 300.

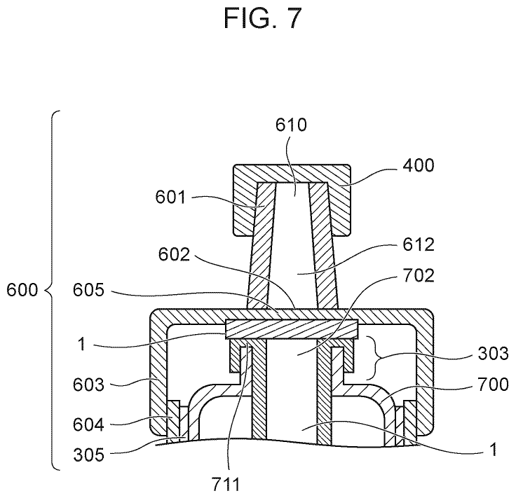

FIG. 7 is an enlarged view of the vicinity of the nozzle portion 600 shown in FIG. 6. An inner peripheral surface of the container attaching portion 603 of the nozzle portion 600 is provided with a spiral externally threaded portion 604, and outer peripheral surface of the shoulder portion 302 of the container portion 300 is provided with a spiral internally threaded portion 305. By rotating and screwing the nozzle portion 600 in a first direction with respect to the container portion 300 with the externally threaded portion 604 and the internally threaded portion 305 being engaged with each other, the nozzle portion 600 can be attached to the container portion 300. By rotating the nozzle portion 600 in a second direction opposite to the first direction with respect to the container portion 300 with the externally threaded portion 604 and the internally threaded portion 305 being engaged with each other, the nozzle portion 600 can be detached from the container portion 300.

It should be noted that an attaching detaching mechanism of the nozzle portion 600 and the container portion 300 is not limited to the aforementioned screwing mechanism, and may be, for example, an engaging mechanism including an engaging portion and an engaged portion or a fitting mechanism including a fitting portion and a fitted portion.

A surface of the communicating portion 602 of the nozzle portion 600 on a side of the container portion 300 is provided with a concave portion 605. The shape of the concave portion 605 is substantially the same as the shape of a fixing portion of the regulating member 1, and the regulating member 1 can be fitted into the concave portion 605. With the regulating member 1 being fitted in the concave portion 605, an outer peripheral portion of the regulating member 1 is heated and the regulating member 1 is thermally welded to the communicating portion 602, thereby fixing the regulating member 1 to the communicating portion 602.

An external dimension of the regulating member 1 may be made larger than an inside-diameter dimension of the concave portion 605, and the regulating member 1 may be fixed to the concave portion 605 by press-fitting the regulating member 1 to the concave portion 605. With the nozzle portion 600 being attached to the container portion 300, the communicating portion 602 of the nozzle portion 600 press-contacts the lead-out opening 702, the regulating member 1 is interposed therebetween and is fixed, and a portion between the communicating portion 602 and the lead-out opening 702 is hermetically sealed.

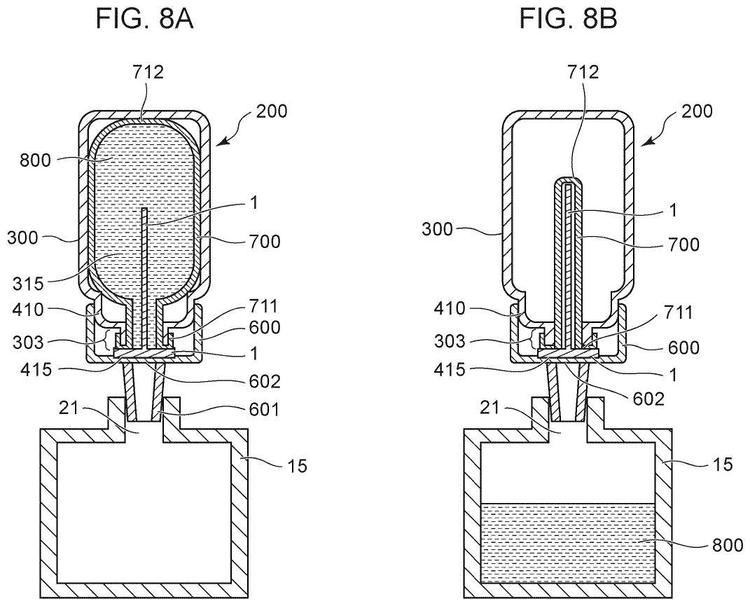

FIGS. 8A and 8B are each a cross-sectional view illustrating a state in which the ink replenishing container 200 is connected to one ink tank 15 of the inkjet printer 11 to replenish with the ink 800 the ink tank 15 from the ink replenishing container 200. As shown in FIGS. 8A and 8B, the ink tank 15 can be replenished with ink by inserting the tip portion 601 of the nozzle portion 600 into the replenishing opening 122. It should be noted that FIG. 8A illustrates a state in which ink remains in the ink storage bag 700, and FIG. 8B illustrates a state directly after the ink tank 15 has been replenished with ink in the ink storage bag 700.

As described above, as ink in the ink storage bag 700 is led out of the lead-out opening 702, the volume of the ink storage bag 700 decreases. Facing surfaces of the ink storage bag 700 come close to each other so as to contact each other. However, in the present embodiment, at least a part of the regulating member for regulating the decrease in the volume of the ink storage bag when the ink in the ink storage bag is led out of the ink storage bag is accommodated in the ink storage bag. Therefore, even if the ink in the ink storage bag 700 is led out, the regulating member 1 suppresses the facing surfaces of the ink storage bag 700 from coming into contact with each other and a part of the ink storage bag from being closed. Consequently, it is possible to decrease the amount of residual ink in the ink storage bag. That is, the ink replenishing container according to the present embodiment is easily used and recycled. In other words, the technologies described in this specification have the potential to contribute to the achievement of a sustainable society, such as a decarbonized society/circular society.

### Regulating Member

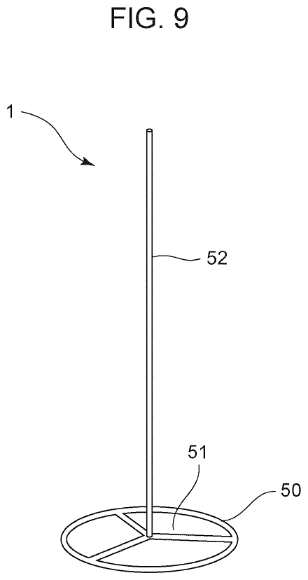

Next, a detailed structure of the regulating member 1 is described. FIG. 9 is a perspective view of the regulating member 1. The regulating member 1 includes a frame portion 50 that defines an opening 53, a beam portion 51 that connects at least two points of the frame portion 50, and a rod-shaped portion 52 that extends in a direction perpendicular to the beam portion 51 from the beam portion 51. In other words, the rod-shaped portion 52 of the regulating member 1 accommodated in the ink storage bag 700 and the container portion 300 has a shape extending along the longitudinal direction (the axial direction) of the container portion 300. It is preferable that the length of the rod-shaped portion 52 of the regulating member 1 in the longitudinal direction thereof be greater than or equal to ½ of the length of the container portion in the longitudinal direction thereof. Therefore, it is possible to further reduce the possibility of the ink storage bag 700 falling down in the container portion 300 and of a part of the ink storage bag 700 being closed.

As described above, the frame portion 50 of the regulating member 1 is attachably and detachably mounted on the nozzle portion 600. If the regulating member 1 is formed so as to be attachable to and detachable from the nozzle portion 600, the regulating member 1 and the nozzle portion 600 can be separately handled. In other words, when one of the nozzle portion 600 and the regulating member 1 is damaged, the undamaged one of the nozzle portion 600 and the regulating member 1 can be reused by combining it with a different member.

On the other hand, the frame portion 50 may be thermally welded to the nozzle portion 600 so as not to be attachable to and detachable from the nozzle portion 600. In this case, while the nozzle portion 600 and the frame portion 50 cannot be handled as separate members, it is possible to reduce the possibility of the regulating member 1 being unintentionally dislodged from the nozzle portion 600. It should be noted that the method of fixing the frame portion 50 to the nozzle portion 600 is not limited to thermal welding.

It is preferable that the regulating member 1 be manufactured by injection molding by using a material that is the same as the material of the container portion 300 or the material of the ink storage bag 700. In such a case, the regulating member 1 and the container portion 300 or the ink storage bag 700 can be recycled in the same way. Alternatively, the regulating member 1 can be manufactured by, for example, machine processing using an SUS material or forming processing use a wire rod.

While, in the present embodiment, the regulating member 1 has been described as including the rod-shaped portion 52, as long as the regulating member 1 is a member that can suppress the ink storage bag 700 from falling down and closing when replenishing the ink tank with ink, the shape of the regulating member is not limited even if the regulating member 1 does not include the rod-shaped portion 52. It is possible to, as a result of fixing the regulating member to a bottom surface of the container portion 300 through the ink storage bag 700, regulate a decrease in the volume of the ink storage bag 700 and reduce the possibility of a part of the ink storage bag 700 being closed.

### Second Embodiment

A structure of an ink replenishing container 200 according to a second embodiment is described. In particular, the present embodiment differs from the first embodiment in a regulating member 1. It should be noted that, in the description below, only portions differing from those of the first embodiment are primarily described, and portions that are the same as those of the first embodiment are not described.

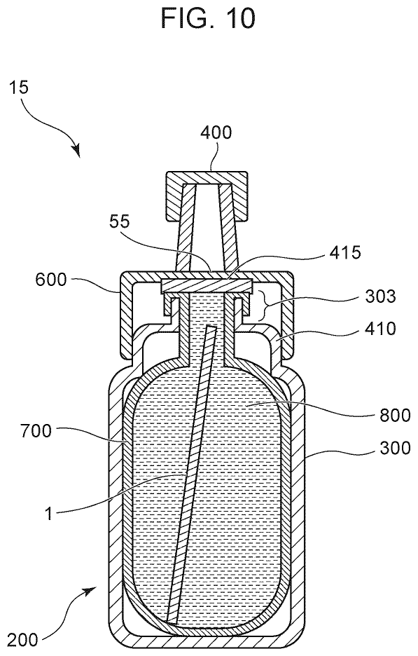

FIG. 10 is a cross-sectional view of an ink replenishing container according to the second embodiment. In an ink replenishing container 200 according to the second embodiment, the regulating member 1 is not fixed to a nozzle portion 600, and the entire regulating member 1 is accommodated in an ink storage bag 700. The ink storage bag can be suppressed from being closed not only when at least a part of the regulating member 1 is accommodated in the ink storage bag 700 as in the first embodiment, but also when the entire regulating member 1 is accommodated in the ink storage bag 700.

In such a case, it is preferable that the regulating member 1 be a type that, when an ink tank is being replenished with ink from the ink replenishing container 200, is not discharged to the outside from the ink replenishing container 200. For example, even if the regulating member 1 includes only a rod-shaped portion 52, as long as the nozzle portion is provided with a filter 55, it is possible to reduce the possibility of the regulating member 1 being discharged to the outside when the ink tank is being replenished with ink. Further, for example, waste contained in the ink stored in the ink storage bag 700 can be held back by the filter 55.

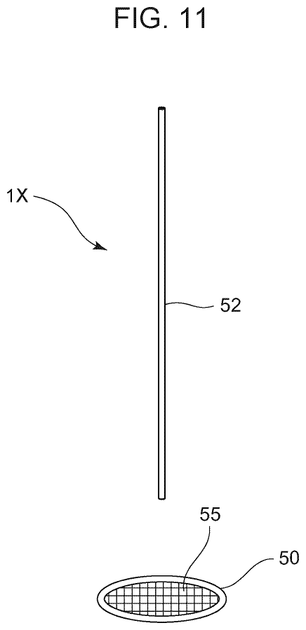

FIG. 11 is a schematic view of the regulating member 1 and the filter 55 according to the second embodiment. Unlike the first embodiment, the regulating member 1 does not include a frame portion 50 and a beam portion 51, and includes only the rod-shaped portion 52. It should be noted that the regulating member 1 may include not only the rod-shaped portion 52, but also other members. It is preferable that the filter 55 be attachable to and detachable from the nozzle portion 600.

When the regulating member 1 falls down in the ink storage bag, the effect of suppressing the falling down of the ink storage bag is reduced. As shown in FIG. 10, when the length of the regulating member 1 is a length from a bottom surface of the ink storage bag 700 to the position of a neck portion 303 of the container portion 300, the possibility of the regulating member 1 being removed from the neck portion 303 is reduced. Therefore, to stably suppress the ink storage bag from being closed, it is preferable that the length of the regulating member 1 (rod-shaped portion) be greater than or equal to the length from a bottom portion 311 to the position of the neck portion 303.

When the entire regulating member 1 is accommodated in the ink storage bag 700, it is preferable that the density of the regulating member 1 be greater than the density of ink stored in the ink storage bag. Therefore, the regulating member 1 sinks in the ink in the ink storage bag, as a result of which it is possible to more stably suppress the ink storage bag 700 from being closed as the volume of the ink storage bag 700 decreases. Further, when the density of the regulating member 1 is greater than the density of ink, even if the rod-shaped portion of the regulating member is made short, the regulating member moves to a position where the regulating member comes into contact with the neck portion when the ink tank is being replenished with ink, as a result of which it is possible to suppress the ink storage bag 700 from being closed.

When the ink type is, for example, pigment ink, a pigment component may precipitate in the liquid. In order to solve this problem, an ink component is stirred by shaking the ink replenishing container 200. When the regulating member 1 is not fixed in the ink replenishing container 200, it is possible to obtain a stirring effect of the ink by swinging the regulating member 1.

Accordingly, even if the ink replenishing container according to the second embodiment is used and ink in the ink storage bag 700 is led out, the regulating member 1 suppresses the facing surfaces of the ink storage bag 700 from coming into contact with each other and a part of the ink storage bag from being closed. Therefore, it is possible to decrease the amount of residual ink in the ink storage bag.

### Reuse and Remanufacturing of Ink Replenishing Container

Next, a method of reusing the ink replenishing container 200 and a method of remanufacturing the ink replenishing container 200 are described. It should be noted that, unless otherwise indicated, the method of reusing the ink replenishing container 200 and the method of remanufacturing the ink replenishing container 200 are common to the ink replenishing container according to the first embodiment and the ink replenishing container according to the second embodiment.

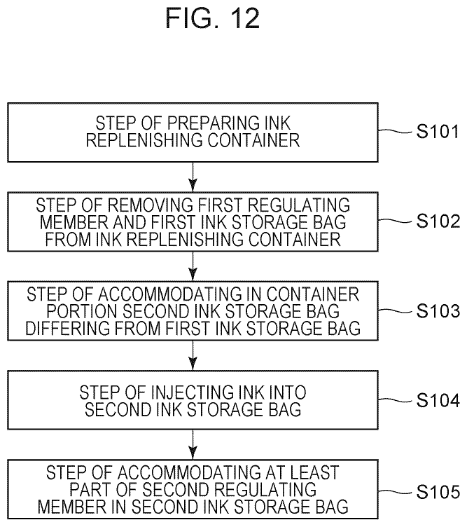

FIG. 12 is a flowchart for describing the method of reusing the ink replenishing container 200 and the method of remanufacturing the ink replenishing method 200. It should be noted that an ink storage bag of a used ink replenishing container 200 is referred to as a “first ink storage bag”, and a regulating member of the used ink replenishing container 200 is referred to as a “first regulating member”.

First, Step S101 is a step of preparing a used ink replenishing container. Here, a used ink replenishing container refers to an opened ink replenishing container or an ink replenishing container that cannot be used even if it is not opened. The preparing step corresponds to collecting the used ink replenishing container.

Next, Step S102 is a step of removing the first regulating member and the first ink storage bag from the ink replenishing container. First, a nozzle portion 600 is removed from the ink replenishing container 200. Then, the first regulating member and the first ink storage bag are removed from the ink replenishing container 200. At this time, since ink is not adhered to a container portion 300, the ink replenishing container 200 can be reused without cleaning the ink replenishing container 200. It should be noted that to remove, for example, waste in the ink replenishing container 200, the container portion 300 may be cleaned.

Next, Step S103 is a step of accommodating in the container portion 300 a second ink storage bag differing from the first ink storage bag. Here, the second ink storage bag is an ink storage bag that does not store ink therein. Similarly to the first ink storage bag, the second ink storage bag has a lead-out opening (also called a second lead-out opening) from which stored ink can be led out, and is a type whose volume decreases as the ink in the second ink storage bag is led out of the second lead-out opening.

Next, Step S104 is a step of injecting ink into the second ink storage bag. After the ink has been injected, the nozzle portion 600 is attached to the container portion 300. At this time, while, from the view point of environmental protection, it is preferable to reuse the nozzle portion 600, a new nozzle portion 600 to which ink is not adhered may be used.

Lastly, Step S105 is a step of accommodating at least a part of a second regulating member in the second ink storage bag. Here, the second regulating member may be the same as or different from the first regulating member. When the second regulating member is the same as the first regulating member, since the total number of members to be reused is increased, this is preferable from the viewpoint of environmental protection. It should be noted that when, after ink replenishing containers 200 have been collected in large numbers, the members are disassembled and are collected based on the types of members and then ink replenishing containers 200 are remanufactured, the second regulating members need not be used in the ink replenishing containers 200 where they were originally used and may be used in ink replenishing containers 200 differing from those where they were originally used.

It should be noted that for the ink replenishing container 200 according to the second embodiment, Step S105 is to be performed to accommodate the entire second regulating member in the second ink storage bag.

Accordingly, the ink replenishing container 200 is reused and remanufactured. In reusing and remanufacturing the ink replenishing container 200, as long as the first ink storage bag is replaced by the second ink storage bag, the other portions may or may not be reused. That is, of the ink replenishing container 200, the ink storage bag 700 to which ink is adhered is discarded. It should be noted that the larger the number of other portions to be reused, the better from the viewpoint of environmental protection.

In this way, even if the ink replenishing container 200 has been reused and remanufactured, the second regulating member regulates a decrease in the volume of the second ink storage bag when ink in the second ink storage bag is led out of the second ink storage bag. That is, even in the ink replenishing container 200 that has been reused and remanufactured, when ink is led out of the second ink storage bag, the second regulating member suppresses the facing surfaces of the second ink storage bag from coming into contact with each other and a part of the ink storage bag from being closed. In other words, the second regulating member regulates bending of another end portion opposite to one end portion (side where the second lead-out opening is formed) of the second ink storage bag with respect to a vertical direction. Therefore, it is possible to decrease the amount of residual ink in the ink storage bag. That is, it is possible to dispel concerns over residual ink with regard to the reuse of the container portion 300, and to promote the reuse of the container portion 300.

Further, since the ink replenishing container can be reused and remanufactured by replacing the ink storage bag of the ink replenishing container, it is possible to decrease the amount of waste compared to when the entire ink replenishing container is discarded and to thus promote the reduction in the amount of waste.

Accordingly, the technologies described in this specification have the potential to contribute to the achievement of a sustainable society, such as a decarbonized society/circular society.

### Detailed Structure of Ink Replenishing Container

Next, a detailed structure of an ink replenishing container is described. It should be noted that matters described in this section are described by using the ink replenishing container according to the first embodiment as an example. Other than the differences in the above-described regulating member, the matters that are described are common to the ink replenishing container according to the second embodiment.

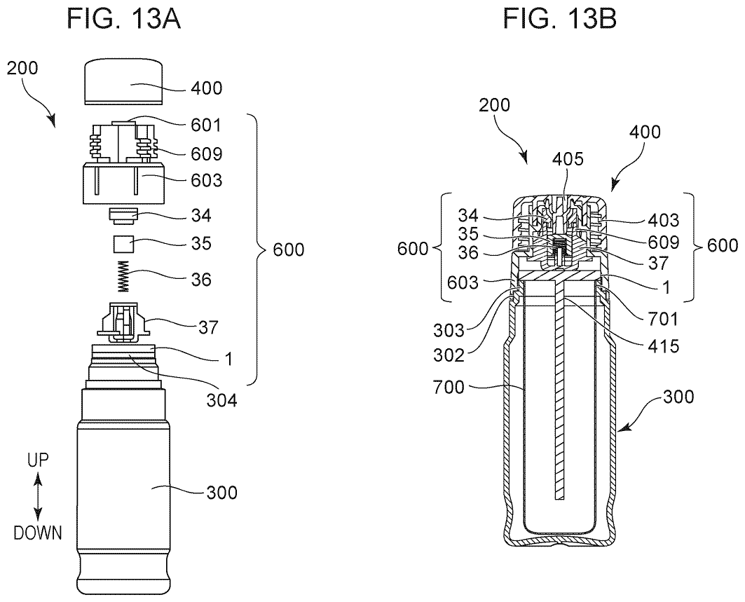

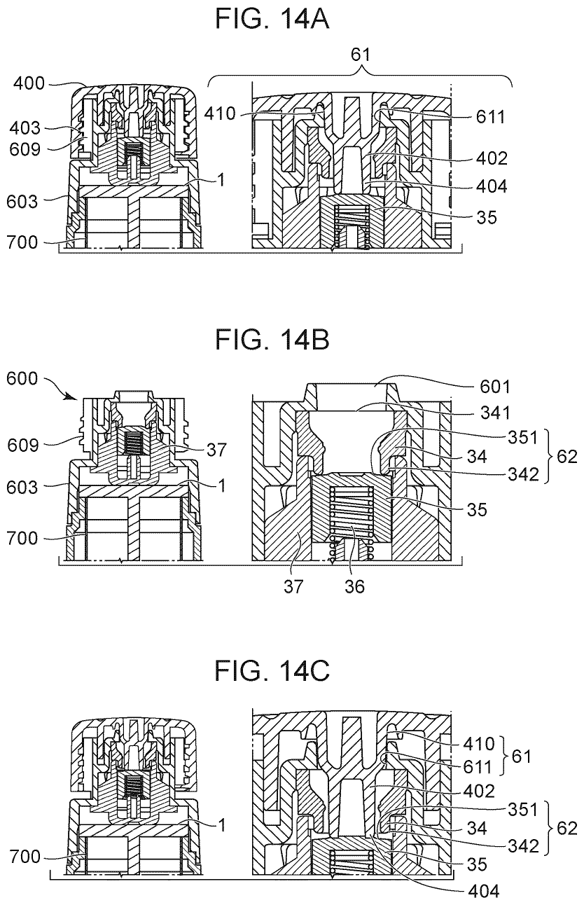

FIGS. 13A and 13B illustrate details of the ink replenishing container, with FIG. 13A being an exploded view illustrating components that make up an ink replenishing container 200, and FIG. 13B being a cross-sectional view of the ink replenishing container 200. FIGS. 14A to 14C are sectional views of details of hermetically sealing structures of the ink replenishing container.

The ink replenishing container 200 includes a container portion 300, an ink storage bag 700, a nozzle portion 600, and a cap 400. An open end 701 of the ink storage bag 700 is fixed to a neck portion 303 of a container portion 300. A filter 55 is fixed to the nozzle portion 600. The nozzle portion 600 is attachable to and detachable from a shoulder portion 302 of the container portion 300. The cap 400 that hermetically seals an opening of a tip portion 601 is attachable to and detachable from the nozzle portion 600. With the nozzle portion 600 being attached to the container portion 300, a regulating member 1 is in close contact with a lead-out opening 702.

A seal 34 that has an opening, a valve body 35 that opens and closes the opening of the seal 34, a spring 36 that urges the valve body 35 in a valve closing direction, a holder 37 that holds the spring 36, and the filter 55 are provided in the nozzle portion 600 of the ink replenishing container 200.

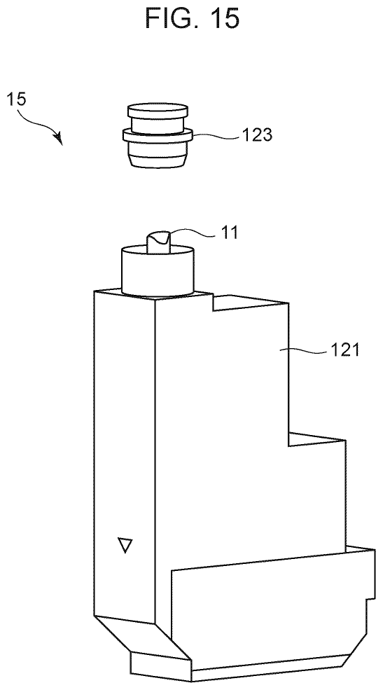

FIG. 15 is a perspective view of an ink tank 15 of an apparatus body. When the ink tank 15 is to be replenished with ink from the ink replenishing container 200, the tip portion of the nozzle portion 600 of the ink replenishing container 200 and a replenishing opening 122 of the ink tank 15 are connected to each other. A concave portion is provided in the vicinity of the tip portion 601 of the nozzle portion 600, a convex portion is provided in the vicinity of the replenishing opening 122 of the ink tank 15, and the concave portion and the convex portion are engageably formed. By engaging the concave portion of the ink replenishing container 200 with the convex portion of the ink tank 15, when the tip portion 601 of the nozzle portion 600 and the replenishing opening 122 of the ink tank 15 are to be connected to each other, the ink replenishing container 200 can be easily positioned. When the replenishing opening 122 of the ink tank 15 and the tip portion 601 of the nozzle portion 600 of the ink replenishing container 200 are connected to each other, ink in the ink replenishing container 200 flows into a tank body 150 of the ink tank 15 through the replenishing opening 122 due to a water head difference.

The ink replenishing container 200 includes a first hermetically sealing structure 61 and a second hermetically sealing structure 62 that can hermetically seal a portion between the inside and the outside of the ink replenishing container 200. As shown in FIG. 14A, the first hermetically sealing structure 61 is hermetically sealed by fitting the cap 400 and the nozzle portion 600 to each other. As shown in FIG. 14B, the second hermetically sealing structure 62 is hermetically sealed by a valve structure in the nozzle portion 600. The hermetically sealing structures are described below.

The left side of FIG. 14A is a cross-sectional view of an upper portion of the ink replenishing container 200 with the cap 400 being mounted on the nozzle portion 600, and the right side of FIG. 14A is an enlarged view thereof. By mounting the cap 400 onto the nozzle portion 600, a cap seal portion 410 of the cap 400 and a nozzle seal portion 611 that is a part of the tip portion 601 of the nozzle portion 600 are fitted to each other, and thus the first hermetically sealing structure 61 is formed. The cap 400 has a projection 402 extending downward from an upper portion of the cap 400, and the cap seal portion 410 is a part of a side surface of the projection 402. The tip portion 601 of the nozzle portion 600 has an opening into which the projection 402 can be inserted, and the nozzle seal portion 611 is a part of an inner peripheral surface defining the opening.

As a structure for mounting the cap 400 onto the nozzle portion 600, a screwing structure can be an exemplification. As shown in FIGS. 13A, 13B, and 14A, an externally threaded portion is formed on an outer peripheral surface of a cap mounting portion 609 of the nozzle portion 600. The cap 400 has an upper surface 405 and a cylindrical portion 403, and an internally threaded portion is formed on an inner peripheral surface of the cylindrical portion 403. By screwing the externally threaded portion and the internally threaded portion to each other, the cap 400 is fixed to the cap mounting portion 609 of the nozzle portion 600, as a result of which the nozzle seal portion 611 and the cap seal portion 410 are in close contact with each other.

An annular gap between the tip portion 601 and the projection 402 is hermetically sealed, and thus the first hermetically sealing structure 61 is formed. It should be noted that an externally threaded portion may be formed on the inner peripheral surface of the cylindrical portion 403 of the cap 400, and an internally threaded portion may be formed on the outer peripheral surface of the cap mounting portion 609 of the nozzle portion 600.

The structure for mounting the cap 400 onto the nozzle portion 600 is not limited to the above-described screwing mechanism. For example, the structure may be a fitting structure, differing from the first hermetically sealing structure 61, for attaching and detaching the cap 400 to and from the nozzle portion 600. For example, the structure may be a fitting structure for fitting an inner peripheral surface of the cap 400 and an outer peripheral surface of the nozzle portion 600 to each other, or a fitting structure (inner cover structure) for fitting an outer peripheral surface of the cap 400 and an inner peripheral surface of the nozzle portion 600 to each other.

The left side of FIG. 14B is a cross-sectional view of the upper portion of the ink replenishing container 200 with the cap 400 not being mounted on the nozzle portion 600, and the right side of FIG. 14B is an enlarged view thereof. The second hermetically sealing structure 62 has a check valve structure that is provided in the nozzle portion 600 of the ink replenishing container 200. As shown in FIG. 14B, the tip portion 601 of the nozzle portion 600 is provided with the seal 34 that is an orifice portion having an opening 341 into which the replenishing opening 122 of the ink tank 15 can be inserted.

The valve body 35 of the check valve is urged in the direction of the seal 34 by the spring 36. Therefore, a lower end portion 342 of the seal 34 and an upper surface 351 of the valve body 35 come into close contact with each other, and thus the opening 341 of the seal 34 is closed, as a result of which the container portion 300 is hermetically sealed. The nozzle portion 600 has a shape formed by connecting a plurality of cylindrical portions having different inside diameters, and a holder 37 that holds the spring 36 at a location below the tip portion 601 is provided in an internal space of the nozzle portion 600. The seal 34 is made of a flexible material such as rubber or elastomer. The second hermetically sealing structure 62 having the check valve structure can maintain the inside of the container portion 300 in a hermetically sealed state even if the cap 400 is not mounted on the nozzle portion 600 as shown in FIG. 14B.

When the ink tank 15 is to be replenished with ink from the ink replenishing container 200, the replenishing opening 122 of the ink tank 15 is inserted into the opening 341 of the seal 34 from the tip portion 601 of the nozzle portion 600 of the ink replenishing container 200. When an end defining the replenishing opening 122 pushes the upper surface 351 of the valve body 35 downward and the valve body 35 moves downward against an urging force of the spring 36, the upper surface 351 of the valve body 35 and the lower end portion 342 of the seal 34 are separated from each other, as a result of which the second hermetically sealing structure is opened. Therefore, since a liquid is flowable into the opening 341 and the container portion 300, ink in the container portion 300 flows into the tank body 150 through the replenishing opening 122 due to a water head difference.

In the ink replenishing container 200 of the present embodiment, there is a timing at which the first hermetically sealing structure 61 and the second hermetically sealing structure 62 are both brought into an open state when the cap 400 is detached from the nozzle portion 600 and when the cap 400 is mounted on the nozzle portion 600.

When the first hermetically sealing structure 61 and the second hermetically sealing structure 62 are both brought into an open state, the inside of the container portion 300 (the ink storage bag 700) and the atmosphere communicate with each other, and the pressure in the container portion 300 (the ink storage bag 700) and the outside air pressure become equal to each other. This is described in detail below.

First, in a state in which the cap 400 is mounted on the nozzle portion 600, as shown in FIG. 14A, the first hermetically sealing structure 61 is in a hermetically sealed state. In the state in which the cap 400 is mounted on the nozzle portion 600, a lower end portion 404 of the projection 402 is formed so as to be disposed below the lower end portion 342 of the seal 34 in an axial direction. Therefore, in the state in which the cap 400 is mounted on the nozzle portion 600, the projection 402 pushes down the valve body 35 to a location below a valve closing position, a gap is formed between the seal 34 and the valve body 35, and the second hermetically sealing structure 62 is brought into an open state. That is, in the state shown in FIG. 14A in which the cap 400 is mounted on the nozzle portion 600, the first hermetically sealing structure 61 is hermetically sealed and the second hermetically sealing structure 62 is in the open state.

The left side of FIG. 14C is a cross-sectional view of the upper portion of the ink replenishing container 200 with detachment of the cap 400 being started from the state in which the cap 400 is mounted on the nozzle portion 600 as shown in FIG. 14A, and the right side of FIG. 14C is an enlarged view thereof. When the detachment of the cap 400 from the nozzle portion 600 is started, the cap 400 moves upward. As the cap 400 moves, the cap seal portion 410 and the nozzle seal portion 611 are separated from each other, and the first hermetically sealing structure 61 is brought into an open state. At this time, as shown in FIG. 14C, the position of the lower end portion 404 of the projection 402 of the cap 400 is still below the position of the lower end portion 342 of the seal 34, and the valve body 35 is disposed at a position reached by being pushed below the valve closing position. Therefore, the second hermetically sealing structure 62 is kept in the open state. At this time, the first hermetically sealing structure 61 and the second hermetically sealing structure 62 are both in the open state.

Thereafter, when the cap 400 is moved further upward, the position of the lower end portion 404 of the projection 402 is moved above the position of the lower end portion 342 of the seal 34, and the projection 402 separates from the valve body 35. At this time, the valve body 35 and the seal 34 come into close contact with each other due to the urging force of the spring 36, and the second hermetically sealing structure 62 is brought into a hermetically sealed state. The first hermetically sealing structure 61 is in the open state.

When the cap 400 is not mounted on the nozzle portion 600, the first hermetically sealing structure 61 is in the open state, and the second hermetically sealing structure 62 is in the hermetically sealed state. When the attachment of the cap 400 to the nozzle portion 600 is started, the cap 400 moved downward. Before, the cap seal portion 410 reaches the position where the cap seal portion 410 is fitted to the nozzle seal portion 611, the lower end portion 404 of the projection 402 of the cap 400 comes into contact with the upper surface 351 of the valve body 35. In this way, the length of the projection 402, the position where the valve body 35 is held by the holder 37, and the positions of the cap seal portion 410 and the nozzle seal portion 611 are set. Therefore, before the first hermetically sealing structure 61 is brought into the hermetically sealed state, the valve body 35 is pushed by the projection 402 and the second hermetically sealing structure 62 is brought into the open state. That is, the first hermetically sealing structure 61 and the second hermetically sealing structure 62 are both in the open state.

When the cap 400 is moved further downward, the cap seal portion 410 reaches the position where the cap seal portion 410 is fitted to the nozzle seal portion 611, and the first hermetically sealing structure 61 is brought into the hermetically sealed state. At this time, the second hermetically sealing structure 62 is in the open state. In this way, there is a timing at which the first hermetically sealing structure 61 and the second hermetically sealing structure 62 are both brought into the open state when the cap 400 is attached to and detached from the nozzle portion 600. Therefore, at this timing, it is possible for the inside of the container portion 300 (the ink storage bag 700) to communicate with the atmosphere and for the internal pressure of the container portion 300 (the ink storage bag 700) and the outside air pressure to become equal to each other. Consequently, when the ink tank 15 is to be replenished with ink from the ink replenishing container 200 by detaching the cap 400 from the nozzle portion 600, it is possible to suppress a blow out of the ink caused by an increase in the internal pressure of the container portion 300. In addition, it is possible to suppress the ink from overflowing the tank body 150.

In the state in which the cap 400 is detached from the nozzle portion 600, since the container portion 300 is kept in the hermetically sealed state by the second hermetically sealing structure 62, it is possible to suppress leakage of ink even if the ink replenishing container 200 falls down from its ordinary position disposed state.

According to the present disclosure, it is possible to provide an ink replenishing container that is easily reused and recycled by, when the apparatus body is replenished with ink from the ink replenishing container, suppressing closure of the ink storage bag and by decreasing the amount of residual ink in the ink storage bag. Further, it is possible to provide a method of remanufacturing such an ink replenishing container and a method of reusing such an ink replenishing container.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-206804, filed Nov. 27, 2024, which is hereby incorporated by reference herein in its entirety.

What is claimed is:

1. An ink replenishing container for replenishing a recording device with ink, the recording device including an ink tank including a replenishing opening and a cap, the replenishing opening opening toward a direction having a vertical direction component and the cap sealing the replenishing opening, comprising:
an ink storage bag that stores ink therein and that has, at one end portion thereof, a lead-out opening out of which the ink is led out; and
a container portion that accommodates the ink storage bag,
wherein the ink storage bag leads the ink in the ink storage bag out of the lead-out opening and decreases in volume, and
wherein at least a part of a regulating member is accommodated in the ink storage bag, the regulating member being provided for, in an orientation in which the ink in the ink storage bag is led out of the ink storage bag, coming into contact with the ink storage bag and regulating bending of another end portion opposite to the one end portion with respect to the vertical direction.

2. The ink replenishing container according to claim 1, further comprising:
a nozzle portion that is attached to the container portion, and that includes a communicating portion and an opening portion, the communicating portion communicating with the lead-out opening and the opening portion opening the communicating portion to outside.

3. The ink replenishing container according to claim 1,
wherein the ink storage bag is attachably and detachably mounted on the container portion.

4. The ink replenishing container according to claim 3,
wherein the container portion includes a neck portion that defines an opening, and
wherein the ink storage bag is attachably and detachably mounted on the neck portion.

5. The ink replenishing container according to claim 1,
wherein the ink storage bag is made of a stretchy material.

6. The ink replenishing container according to claim 5,
wherein the stretchy material includes at least one material selected from the group consisting of butyl rubber, ethylene propylene rubber, silicone rubber, and thermoplastic elastomer.

7. The ink replenishing container according to claim 1,
wherein the regulating member extends along a longitudinal direction of the container portion.

8. The ink replenishing container according to claim 7,
wherein a length of the regulating member in a longitudinal direction thereof is greater than or equal to ½ of a length of the container portion in the longitudinal direction thereof.

9. The ink replenishing container according to claim 2,
wherein the regulating member includes a frame portion that defines an opening, a beam portion that connects at least two points of the frame portion, and a rod-shaped portion that extends in a direction perpendicular to the beam portion from the beam portion.

10. The ink replenishing container according to claim 9,
wherein the frame portion is attachably and detachably mounted on the nozzle portion.

11. The ink replenishing container according to claim 9,
wherein the frame portion is thermally welded to the nozzle portion.

12. The ink replenishing container according to claim 9,
wherein a length of the rod-shaped portion in a longitudinal direction thereof is greater than or equal to ½ of a length of the container portion in a longitudinal direction thereof.

13. The ink replenishing container according to claim 2,
wherein the regulating member is not fixed to the nozzle portion, and
wherein the regulating member in an entirety thereof is accommodated in the ink storage bag.

14. The ink replenishing container according to claim 13,
wherein a density of the regulating member is greater than a density of the ink stored in the ink storage bag.

15. A method of remanufacturing an ink replenishing container,
the ink replenishing container being provided for replenishing a recording device with ink, the recording device including an ink tank including a replenishing opening and a cap, the replenishing opening opening toward a direction having a vertical direction component and the cap sealing the replenishing opening,
the ink replenishing container including
a first ink storage bag that stores ink therein and that has at one end portion thereof a first lead-out opening out of which the ink is led out; and
a container portion that accommodates the first ink storage bag,
wherein the first ink storage bag leads the ink in the first ink storage bag out of the first lead-out opening and decreases in volume, and
wherein at least a part of a first regulating member is accommodated in the first ink storage bag, the first regulating member being provided for, in an orientation in which the ink in the first ink storage bag is led out of the first ink storage bag, coming into contact with the first ink storage bag and regulating bending of another end portion opposite to the one end portion with respect to the vertical direction,
the method comprising:
preparing the ink replenishing container;
removing the first regulating member and the first ink storage bag from the ink replenishing container;
accommodating in the container portion a second ink storage bag differing from the first ink storage bag;
injecting ink into the second ink storage bag; and
accommodating at least a part of a second regulating member in the second ink storage bag,
wherein the second ink storage bag includes at one end portion thereof a second lead-out opening out of which the ink stored in the second ink storage bag is led out, and leads the ink in the second ink storage bag out of the second lead-out opening and decreases in volume, and
wherein, in an orientation in which the second ink storage bag leads out the ink in the second ink storage bag, the second regulating member comes into contact with the second ink storage bag and regulates bending of another end portion opposite to the one end portion with respect to the vertical direction.

16. The method of remanufacturing the ink replenishing container according to claim 15,
wherein the first regulating member and the second regulating member are a same member.

17. The method of remanufacturing the ink replenishing container according to claim 15,
wherein the first regulating member and the second regulating member are different members.

18. A method of reusing an ink replenishing container,
the ink replenishing container being provided for replenishing a recording device with ink, the recording device including an ink tank including a replenishing opening and a cap, the replenishing opening opening toward a direction having a vertical direction component and the cap sealing the replenishing opening,
the ink replenishing container including
a first ink storage bag that stores ink therein and that has at one end portion thereof a first lead-out opening out of which the ink is led out; and
a container portion that accommodates the first ink storage bag,
wherein the first ink storage bag leads the ink in the first ink storage bag out of the first lead-out opening and decreases in volume, and
wherein at least a part of a first regulating member is accommodated in the first ink storage bag, the first regulating member being provided for, in an orientation in which the ink in the first ink storage bag is led out of the first ink storage bag, coming into contact with the first ink storage bag and regulating bending of another end portion opposite to the one end portion with respect to the vertical direction,
the method comprising:
preparing the ink replenishing container;
removing the first regulating member and the first ink storage bag from the ink replenishing container;
accommodating in the container portion a second ink storage bag differing from the first ink storage bag;
injecting ink into the second ink storage bag; and
accommodating at least a part of a second regulating member in the second ink storage bag,
wherein the second ink storage bag includes at one end portion thereof a second lead-out opening out of which the ink stored in the second ink storage bag is led out, and leads the ink in the second ink storage bag out of the second lead-out opening and decreases in volume, and
wherein, in an orientation in which the second ink storage bag leads out the ink in the second ink storage bag, the second regulating member comes into contact with the second ink storage bag and regulates bending of another end portion opposite to the one end portion with respect to the vertical direction.

19. The method of reusing the ink replenishing container according to claim 18,
wherein the first regulating member and the second regulating member are a same member.

20. The method of reusing the ink replenishing container according to claim 18,
wherein the first regulating member and the second regulating member are different members.
